(19) United States
(12) Patent Application Publication
(10) Pub. No.: US 2012/0263063 A1
(43) Pub. Date: Oct. 18, 2012

(54) Client Entity, Network Entity and Data Replacement Entity

(75) Inventors: Daniel Catrein, Wurselen (DE); Frank Hartung, Herzogenrath (DE); Markus Kampmann, Aachen (DE); Thorsten Lohmar, Aachen (DE); Thomas Rusert, Kista (SE); Johannes Willig, Herzogenrath (DE)

(73) Assignee: TELEFONAKTIEBOLAGET LM ERICSSON (PUBL), Stockholm (SE)

(21) Appl. No.: 13/503,823

(22) PCT Filed: Oct. 26, 2009
(86) PCT No.: PCT/EP2009/064064

§ 371 Date: Jun. 29, 2012

(51) Int. Cl. H04L 12/24; H04L 12/26

(52) U.S. Cl. 370/252; 370/389

(57) ABSTRACT

The present invention relates to a client entity being capable of communicating over a communication network. The client entity comprises a receiver (101) for receiving scheduled data and for receiving a quality indicator indicating a quality of the scheduled data, a quality monitor (103) for monitoring the quality of the scheduled data upon the basis of the quality indicator, a processor (105) for providing a data replacement request if the quality of the scheduled data fails to meet a quality requirement, and a transmitter (107) for transmitting the data replacement request towards the communication network to request replacement data representing another version of the scheduled data.

### BACKGROUND

The present invention relates to communicating data over communication networks, in particular to streaming data over communication networks.

Today's communication networks are designed to support different kinds of communication services such as data streaming over a communication network to a dedicated receiver. Unfortunately, in particular in the case of mobile communication networks, a quality of a communication link may vary which may result in a varying bandwidth affecting the maximum available data rate. Additionally, the available data rate may fluctuate due to congestions appearing in mobile and in fixed communication networks.

In order to cope with the aforementioned varying link characteristics, adaptive streaming techniques may be employed, wherein e.g. a content rate representing a media rate may be adjusted to the current available link data rate in the network. In particular in the case of a pre-encoded and stored content, a stream switching approach may be used, wherein the same content is encoded by a media encoder with different rates and stored in a streaming server. During data transmission, the streaming server may change a data rate by adapting the content data rate to the current link data rate, and transfer the respective content version. If the content to be transmitted represents a real-time application then the media encoder may further be adjusted in such a way that a resulting content or media rate corresponds to the current link data rate.

The varying data rate due to the adaptive streaming approach is, however acceptable if the streamed content such as video content is immediately reproduced. The fluctuating data quality resulting from the adaptive streaming approach may often be not satisfying if the streamed data are first recorded and then reproduced. In order to obtain a higher quality recorded version of e.g. a video content, a user may download a higher quality version of the complete streamed data.

### SUMMARY

It is the object of the invention to provide a more efficient concept for handling data being transmittable with different qualities over a communication network.

This object is achieved by the features of the independent claims. Further embodiments are apparent from the dependent claims, from the description and from the accompanying drawings.

The invention is based on the finding that a more efficient concept for handling data which may be transmitted with different qualities over a communication network may be achieved when also a quality indicator indicating the data quality is transmitted. The quality indicator preferably indicates the quality of the data which may be scheduled for transmission to a plurality of receivers or, in case of data streaming, to a dedicated client entity. Based on the quality indicator, only parts of the received data, e.g. streamed data, may be replaced whereby the received data may be repaired by the client entity.

According to an aspect, the invention relates to a client entity being capable of communicating over a communication network. The client entity may comprise a receiver for receiving scheduled data and for receiving a quality indicator indicating a quality of the scheduled data, a quality monitor for monitoring the quality of the scheduled data upon the basis of the quality indicator, a processor for providing a data replacement request if the quality of the scheduled data fails to meet a quality requirement, and a transmitter for transmitting the data replacement request towards the communication network in order to request replacement data representing another version of the scheduled data.

The scheduled data may be represented by a plurality of bits or by a byte or by a plurality of bytes carrying certain information, e.g. video information and/or audio information. Furthermore, the scheduled data may carry information relating to at least a part of a picture or to a picture or to a group of pictures (GoP). The scheduled data may be located in one or in more transmission frames.

The quality indicator may be received together with the scheduled data or separately over the same or another communication channel of the communication network. The quality indicator may be formed by one or more bits representing digital values pointing at a quality of the scheduled data. Furthermore, e.g. in case of an extended header, the quality may also be expressed as textual information.

The quality monitor may be configured to analyze the quality indicator in order to monitor the quality of the scheduled data. Based thereon, the processor may provide the data replacement request if the quality of the scheduled data fails to meet the quality requirement or, otherwise, may not provide any data replacement request. Preferably, the data replacement request is provided after the quality monitor has monitored the quality of the scheduled data.

According to an embodiment, the quality of the scheduled data fails to meet the quality requirement if the quality indicator fails to comply with a quality measure, or if the quality of the scheduled data is lesser than a quality of a received further scheduled data. The quality measure may be a quality threshold, wherein the quality monitor or the processor may be configured to compare the quality indicator with the quality threshold. Depending on the choice of the quality threshold, the quality of the scheduled data fails to meet the quality requirement if the quality indicator is below or above the quality threshold. Furthermore, the quality measure may comprise a value range, wherein the quality indicator may fail to comply with the quality measure if it is outside the value range. A comparison with the quality measure may be avoided if the qualities of scheduled data received at different time instants are compared with each other using e.g. the quality indicators, wherein the quality measure is determined by a respectively higher quality.

Preferably, the replacement request is transmitted in order to request replacement data representing a higher quality version of the scheduled data. However, the replacement request may also be transmitted in order to request a lower quality version of the scheduled data if, at the client entity, the available processing resources are not sufficient to process the currently received scheduled data, or if re-streaming is to be performed.

According to an embodiment, the receiver may be configured to receive information, e.g. meta data, allowing a proper interpretation of the quality indicator. This information may be received e.g. according to the Session Description Protocol (SDP). Furthermore, this information may further indicate available qualities of scheduled data, e.g. video qualities. Thus, the client entity receiving the quality indicator may be informed about the available video qualities via additionally signaled information contained in the SDP. For this purpose, the SDP may comprise media sections for each available video quality along with information as to how this quality may be identified in the data streams, e.g. media streams. Depending on the implementation enabling signaling the quality information in the RTP or RTCP packets, this may be a CSRC or a value of a header field (RTP: Real-time Transmission Protocol; RTCP: Real-time Control Protocol).

According to an implementation, the receiver, e.g. a HTTP receiver, may be configured to receive the replacement data. According to another implementation, the client entity may comprise a further receiver, e.g. a HTTP receiver, for receiving the replacement data.

According to an embodiment, the client entity may be configured to replace the scheduled data with the replacement data. By way of example, the client entity may first record the scheduled data into a file, e.g. into a MPEG-file (MPEG: Moving Picture Experts Group), in particular into MPEG4 part 12 file defining the ISO base file format that is used as a basis for many recent file formats, and to replace at least parts of the recorded, scheduled data in the file with the replacement data. The data replacement may be performed by either the quality monitor or by the processor. With reference to MPEG4, a basis for a plurality of recording files may be the MPEG4 ISO media file format MPEG4, Part 12, wherein derived file formats may include the MP4 file format MPEG4, Part 14, the 3GPP file format as specified in 3GPP TS 26.244, or the 3GPP2 file format. In the following, for the sake of simplicity, the term MPEG4 will be used.

According to an embodiment, the transmitter may be configured to transmit the data replacement request using the Hyper Text Transfer Protocol or a Uniform Resource Locator or a Uniform Resource Identifier. Generally, the data replacement request may be transmitted upon the basis of any communication protocol enabling the transmitter to transmit the data replacement request towards the communication network.

According to an embodiment, the receiver may be a streaming receiver being configured to receive a data stream comprising the scheduled data, wherein the data stream may be communicated upon the basis of the Hyper Text Transfer Protocol or other protocols enabling streaming data.

According to an embodiment, the scheduled data may be arranged at a certain position in a data stream. The certain position may be associated with a certain time interval within which the scheduled data is arranged in the data stream, or with a certain index range indicating the arrangement of the scheduled data in the data stream. Furthermore, the certain position of the scheduled data may be associated with certain byte range within the data stream. The data replacement request may thus comprise information indicating the certain position, e.g. a time stamp or a number indicating the time interval or the value range. The client entity may comprise mapping information stored e.g. in a mapping table such as a time-to-sample table arranged in a header of a MPEG4 file. The mapping information may be downloaded via e.g. HTTP from e.g. a replacement data entity providing replacement data to allow mapping respective time intervals of the sections, i.e. scheduled data, which shall be replaced by replacement data to the section of the file which may be stored at the data replacement entity.

According to an embodiment, the replacement data may be arranged at a certain position in a replacement data array comprising the replacement data and a further replacement data. Hence, the data replacement request may indicate the certain position of the replacement data in the replacement data array in order to indicate the replacement data.

According to an embodiment, the client entity may be configured to save the scheduled data and the quality indicator, e.g. to record the scheduled data into an MPEG file such as MPEG4 file together with the quality indicator.

According to an embodiment, the transmitter may be configured to transmit a request towards the communication network to request a transmission, e.g. streaming, of the scheduled data.

According to an embodiment, the client entity may comprise a reproducing device, e.g. a display and/or a loudspeaker, for reproducing content represented by the scheduled data.

According to an aspect, the invention relates to a replacement data entity, e.g. a repair server, which may be capable of communicating over a communication network. The replacement data entity may comprise a receiver for receiving a data replacement request over the communication network, wherein the data replacement request may indicate a replacement data. The replacement data entity may further comprise a data provider for providing the replacement data in response to the data replacement request. The replacement data entity may further comprise a transmitter for transmitting the replacement data towards the communication network.

According to an embodiment, the replacement data entity may comprise a memory for storing replacement data with a certain quality. The memory may be arranged to form a memory array for storing a replacement data array comprising replacement data with different qualities. Furthermore, the memory may store replacement data representing data having a quality which is higher than a quality of e.g. data to be replaced by the replacement data.

According to an embodiment, the data replacement request may indicate a certain position of the scheduled data within a data stream. The replacement data may be arranged in a replacement data array which may be stored in a memory. Thus, the data provider may be configured to determine the position of the replacement data in the replacement data array upon the basis of the certain position of the scheduled data in the data stream. For example, the scheduled data may represent a certain audio or video content which enables the data provider, e.g. on a time basis, to determine a position of a corresponding audio or video content represented by the replacement data with another, e.g. higher, quality. However, the replacement request may directly indicate the position of the replacement data in the replacement data array.

According to an embodiment, the replacement data may be arranged in a replacement data array, wherein the data replacement request indicates a certain position of the replacement data in the replacement data array. Hence, the provider may be configured to access the replacement data upon the basis of the certain position of the replacement data in the replacement data array.

The replacement data entity may comprise mapping information stored e.g. in a mapping table such as a time-to-sample table arranged in a header of a MPEG4 file. The mapping information may be used for mapping respective time intervals of the sections comprising replacement data to the section of the file which shall be replaced at a client entity requesting the replacement data.

According to an embodiment, the transmitter may be configured to transmit the replacement data towards the communication network upon the basis of the Hyper Text Transfer Protocol or upon the basis of the Real-time Transport Protocol. The transmitter may be configured to arrange the replacement data in a Hyper Text Transfer Protocol frame and to transmit the resulting frame towards the communication network.

According to an aspect, the invention relates to a network entity for communicating over a communication network. The network entity may comprise a scheduler for scheduling data to obtain scheduled data for transmission, a qualifier for providing a quality indicator indicating a quality of the scheduled data, and a transmitter for transmitting the scheduled data and the quality indicator over the communication network.

The network entity may be e.g. a streaming server arranged for streaming data over the communication network. The scheduler may be configured to schedule data in response to a data or content request received from the communication network. Hence, the scheduler may schedule data representing certain content, e.g. audio or video content upon request. In order to qualify the scheduled data, the qualifier may provide a quality indicator indicating a quality of the scheduled data. By way of example, the qualifier may associate or link the quality indicator with the scheduled data. Preferably, the scheduled data and the quality indicator may be transmitted together, e.g., in the same streaming session or in the same stream, over the communication network to a client entity.

According to some implementations, the network entity may use adaptive streaming via HTTP to transmit media data and corresponding quality indicator to the client entity. Exemplarily, the adaptive streaming via HTTP may be realized using fragmented MP4 files or using short MP4 segments or may be realized using the HTTP live streaming approach or similar methods based on MPEG files or MPEG2 transport streams.

According to an embodiment, the scheduler may be configured to adaptively schedule the data transmission by selecting first data being associated with a first quality or by selecting second data being associated with a second quality in dependence on current network conditions. In particular, the scheduler may enable an adaptive streaming by adapting e.g. the transmission data rate, which may be different for different data qualities, to the current link for channel conditions.

According to an embodiment, the network server may comprise a receiver for receiving a request signal requesting a transmission of certain information over the communication network, wherein the scheduler may be configured to schedule the data for transmission in response to the request signal, and wherein the scheduled data may at least partly comprise the certain information. Hence, the scheduler may be configured to schedule data upon request in order to transmit the certain information over the communication network to e.g. the aforementioned client entity.

According to an embodiment, the network entity may further comprise a composer for composing a transmission frame upon basis of the scheduled data and the quality indicator. In particular, the composer may be configured to arrange the quality indicator in a header field of a transmission frame comprising the scheduled data. The transmission frame may be based upon the Real-time Transport Protocol or upon the Hyper Text Transfer Protocol.

According to an embodiment, the transmitter may be configured to transmit information, e.g. meta data, allowing a proper interpretation of the quality indicator. This information may be transmitted e.g. according to the Session Description Protocol (SDP). In addition, this information may further indicate available qualities of scheduled data, e.g. video qualities. Thus, a client entity receiving the quality indicator may be informed about the available video qualities via additionally signaled information contained in the SDP. For this purpose, the SDP may comprise media sections for each available radio quality along with information as to how this quality may be identified in the data streams, e.g. media streams. Depending on the implementation enabling signaling the quality information in the RTP or RTCP packets, this may be a CSRC or a value of a header field.

According to an embodiment, the quality indicator may indicate a data rate, in particular an audio data rate or a video data rate, and/or a compression rate, in particular an audio compression rate and/or a video compression rate, or a resolution at which the scheduled data represents certain information or content, in particular an audio resolution or a video resolution, and/or a compression error. These examples apply generally to all quality indicators referred to herein.

According to an embodiment, the network entity may comprise the aforementioned replacement data entity which may be implemented as a part of the network entity. In that case, the network entity and the replacement data entity may share the receiver and the transmitter comprising the features as described with respect to the respective entity.

According to an aspect, the invention relates to a communication system comprising the aforementioned client entity, the aforementioned replacement data entity and the aforementioned network entity. These entities may be arranged to communicate over a communication network with each other.

According to an aspect, the invention further relates to a method for managing data being receivable over a communication network. Preferably, the method comprises receiving schedule data and receiving a quality indicator indicating a quality of the scheduled data, monitoring the quality of the scheduled data upon the basis of the quality indicator, providing a data replacement if the quality of the scheduled data fails to meet a quality requirement, and transmitting the data replacement request towards the communication network to request replacement data representing another version of the scheduled data.

Further embodiments of the method for managing data are directly derivable from the functionality of the client entity.

According to an aspect, the invention relates to a method for providing replacement data over a communication network. The method comprises receiving a data replacement request over the communication network, the data replacement request indicating the replacement data, providing the replacement data in response to the data replacement request, and transmitting the replacement data towards the communication network.

Further embodiments of the method for providing replacement data are directly derivable from the functionality of the data replacement entity.

According to an aspect, the invention relates to a method for communicating data over a communication network. The method comprises scheduling data to obtain scheduled data for transmission, providing a quality indicator indicating a quality of the scheduled data, and transmitting the scheduled data and the quality indicator over the communication network.

Further embodiments of the method for communicating data are directly derivable from the functionality of the network entity.

According to an aspect, the invention relates to a method for communicating, comprising managing data according to the method for managing data, providing replacement data according to the method for providing replacement data according to the method for providing replacement data, and communicating data according to the method for communicating data.

Further embodiments of the method for communicating are directly derivable from the functionality of the communication system.

According to a further aspect, the invention relates to a computer program comprising a program code for executing at least one of the methods when run in a computer.

### BRIEF DESCRIPTION OF THE DRAWINGS

Further embodiments of the invention will be described with respect to the following figures, in which:

FIG. 1 shows a client entity;

FIG. 2 shows a data replacement entity;

FIG. 3 shows a network entity;

FIG. 4 shows a communication system;

FIG. 5 shows a transmission frame, and

FIG. 6 shows a communication system.

### DETAILED DESCRIPTION

Before embodiments of the invention are described in detail, it is to be understood that this invention is not limited to the particular component parts of the devices described or steps of the methods described as such devices and methods may vary. It is also to be understood that the terminology used herein is for purposes of describing particular embodiments only, and is not intended to be limiting.

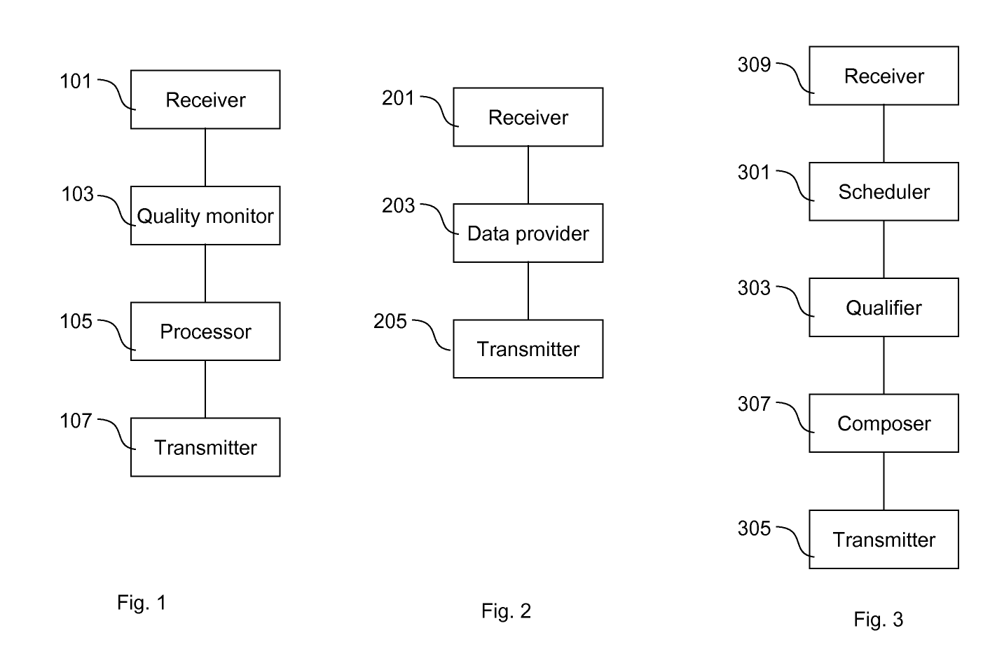

FIG. 1 shows a client entity comprising a receiver 101 being configured to receive scheduled data and to receive a quality indicator indicating a quality of the scheduled data, a quality monitor 103 coupled to the receiver 101 for monitoring the quality of the scheduled data upon the basis of the quality indicator, a processor 105 for providing a data replacement request if the quality of the scheduled data fails to meet a quality requirement, and a transmitter 107 for transmitting the data replacement request towards the communication network to request replacement data representing another version of the scheduled data. According to an embodiment, the quality monitor may directly receive the scheduled data from the receiver. According to another embodiment, the scheduled data may first be recorded into e.g. a file together with the quality indicator, so that the quality monitor 103 may evaluate the recording file in order to monitor the quality of the scheduled data.

According to some implementations, the client entity may display e.g. a streamed video and record it in parallel into e.g. a MPEG4 compliant MP4 or 3GP file according to a 3GPP file format defined by the 3^{rd} Generation Partnership Project for 3G UMTS multimedia services (UMTS: Universal Mobile Telecommunication System). With reference to MPEG4, a basis for a plurality of recording files may be the MPEG4 ISO media file format MPEG4, Part 12, wherein derived file formats may include the MP4 file format MPEG4, Part 14, the 3GPP file format as specified in 3GPP TS 26.244, or the 3GPP2 file format.

The client entity may further comprise a logging entity recording the quality of e.g. streamed media comprising the scheduled data together with the actual media data representing the scheduled data as signaled to the client entity over the communication network from e.g. a remote network entity. In order to record the quality of e.g. a video content, the quality indicator may also be recorded into the MPEG4 file or into an extra file which enables the client entity to determine for which time intervals the quality of the recorded streams is below a user defined or a pre-defined threshold.

The quality information represented by the quality indicator may be stored together with samples forming the scheduled data, as additional information for sample groups forming the scheduled data or in sample descriptors. Hence, time intervals, during which the quality of the scheduled data was e.g. below a quality threshold, may be identified. The extra file mentioned above may e.g. contain direct mappings of time intervals to a certain quality, which may be expressed by a certain quality indicator, in a table or in a lookup table or in a XML format (XML: Extensible Markup Language).

When recording the scheduled data and/or the quality indicator into a file, e.g. time stamps may be set in the file in a predefined way in order to support a later repair of the file by replacing the scheduled data with the replacement data. Preferably, such time stamps may be set by re-using the time stamps which may be present in packets such as RTP packets transmitted through the communication network in e.g. streaming applications. In case of a time drift, an automatic correction may be performed upon the basis of the RTP protocol via RTCP sender reports which may contain a time reference information e.g. upon the basis of the Network Time Protocol (NTP).

According to some implementations, the RTP time stamps may be used together with the RTCP sender reports for other reasons, as, for example, the RTP time stamps are typically not synchronized between streams, e.g. audio streams and/or video streams.

FIG. 2 shows a replacement data entity comprising a receiver 201 for receiving a data replacement request over a communication network. The replacement data entity further comprises a data provider 203 which is coupled to the receiver 201. Preferably, the data provider 203 is configured to provide the replacement data in response to the data replacement request provided by the receiver 201. The replacement data may be transmitted by a transmitter 205 towards the communication network to e.g. a remote client entity, e.g. to the client entity as described with reference to FIG. 1.

With reference to FIGS. 1 and 2, the data replacement request may be transmitted by the transmitter 107 of the client entity in order to request the replacement data if the quality of the scheduled data received by the client entity is not sufficient. In order to enable the replacement data entity to determine the replacement data representing e.g. a higher quality version of the replacement data, the client entity may determine upon the basis of the information provided by e.g. an optional logging entity, which sections of the data stream or of the recorded file need to be repaired. In this regard, each section may represent scheduled data associated with a quality indicator enabling the client entity to determine the quality of the respective section. The sections to be repaired may be sections for which the quality was below e.g. a certain user or a predefined threshold. By inspecting the recorded information, the client entity may determine at which time instant or during which time intervals the quality was too low in order to determine time intervals within which the data should be repaired, i.e. replaced by the replacement data. The client entity may also utilize additional information requested from the replacement data entity such as the aforementioned time-to-sample table.

FIG. 3 shows a block diagram of a network entity which may form a network streaming server. The network entity comprises a scheduler 301 for scheduling data to obtain scheduled data for transmission, a qualifier 303 being configured to provide a quality indicator indicating a quality of the scheduled data by e.g. associating or linking the indicator to the scheduled data, and a transmitter 305 for transmitting the scheduled data and the quality indicator towards the communication network.

The network entity may further comprise a composer 307, which may be arranged between the qualifier 303 and the transmitter 305, for composing a transmission frame comprising the scheduled data and the quality indicator associated therewith.

The network entity may further comprise a receiver 309 for receiving a request signal requesting a transmission of the scheduled data. Thus, the scheduler 301 may schedule the transmission data in response to the request signal received and provided by the receiver 309.

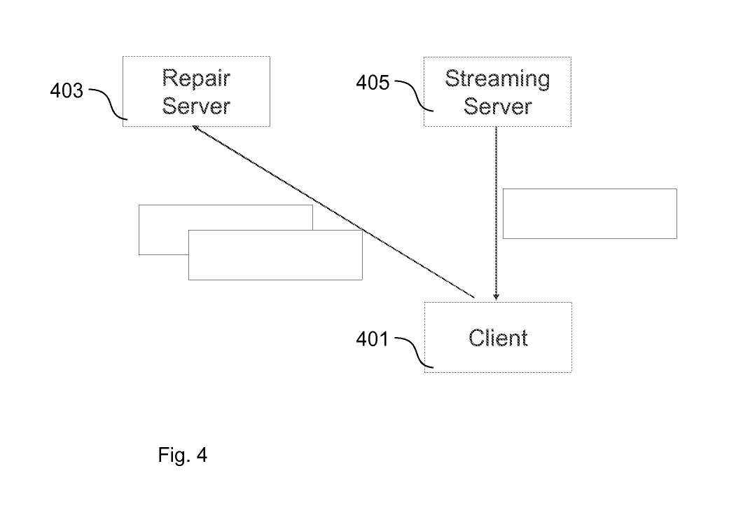

FIG. 4 shows a communication system comprising a client entity 401, a data replacement entity 403 and a network entity 405. The entities 401 to 405 may respectively correspond to the entities described with reference to FIGS. 1 to 3.

According to some implementations, the client entity 401 may receive from the network entity 405 forming e.g. a streaming server a RTP data stream together with the quality indicator. If the data stream comprises scheduled data having a quality which does not comply with certain quality requirements, then the client entity 401 may transmit the data replacement request, e.g. a HTTP repair request, to the data replacement entity 403 forming e.g. a repair server. The data replacement request may include intervals, e.g. time intervals or byte intervals, indicating the scheduled data to be replaced or directly indicating the replacement data.

According to some implementations, the network entity 405 may be a 3GPP PSS (Packed-switched Streaming) compliant server capable of performing adaptive streaming to the client entity 401. The data replacement entity 403 may offer the same media data as the network entity 405 for download e.g. via HTTP in order to repair recorded streams. The client entity 401 may be capable of receiving and recording media streams from the network entity 405 and can request data from the data replacement entity 403, e.g. via HTTP. After selecting some content, e.g., via a web browser, the client entity 401 may request the media streams from the network entity 405 e.g. via RTSP and the network entity 405 may begin to stream the content to the client entity 401 using e.g. the PSS streaming approach. In order to adapt to changing network conditions, the network entity 405 may use adaptive streaming, i.e. may change, the date rate of the streamed media which is supported by the PSS approach.

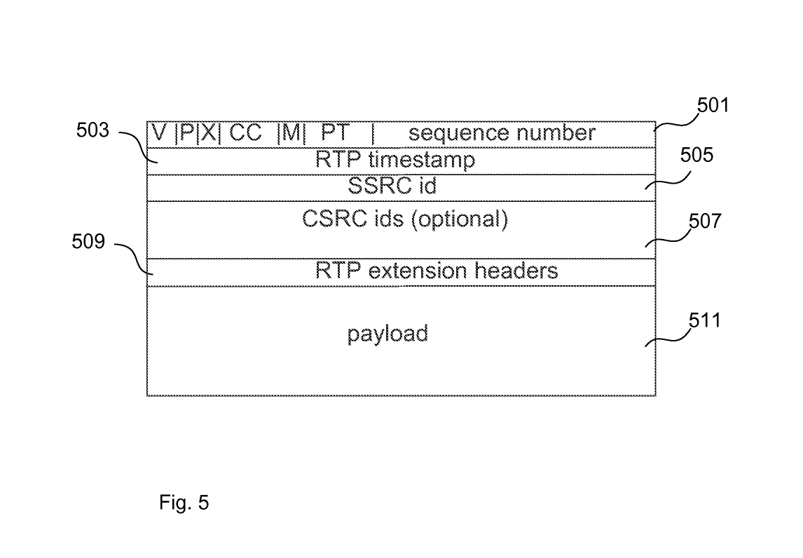

The quality indicator or the replacement data may be transmitted upon the basis of transmission frames or packets as depicted in FIG. 5 showing, by way of example, a structure of a RTP packet comprising a sequence number field 501, a RTP time stamp field 503, a SSRC field 505, optionally, CSRC header 507, RTP extension headers 509 and a payload field 511.

In order to signal the quality indicator, the header of the RTP packet, e.g. the CSRC header 507 or the extension header 509 may be used. The CSRC header 507 may be used to signal different sources contributing to a RTP media stream. The different qualities can be seen as such different sources. That is, each quality is assigned a different CSRC id (CSRC identification), and the network entity 405 includes the CSRC id of the currently selected quality into the RTP header. The RTP packet headers may also be extended by extension headers 509. Defining a new extension header to signal the media quality is an additional option.

According to some implementations, the network entity 405 may transmit information about currently streamed media quality, i.e. the quality indicator, together with the media stream to the client entity 401, wherein the quality information may be arranged in a header of the RTP packet. In other words, the streamed media quality may be signaled in the header of the media stream's RTP packets. It is, however, possible but not always necessary to include this information into all packets as including this information may be sufficient upon switching, i.e. changing, the quality or, in case of video transmission, upon the basis of a GOP or upon a frame basis.

According to some implementations, extended RTCP sender reports may be utilized, wherein RTP streams may be accompanied by RTCP packets used e.g. to synchronize the time between different RTP streams. RTCP may contain different standardized messages and is extensible, e.g. via Application Specific Messages (APP). Furthermore, a new APP can be defined in order to signal the currently streamed media quality to the client entity 401. Such an RTCP message with APP payload could either be transmitted periodically in regular intervals or transmitted upon each adaptation of the media rate and quality by the network entity 405.

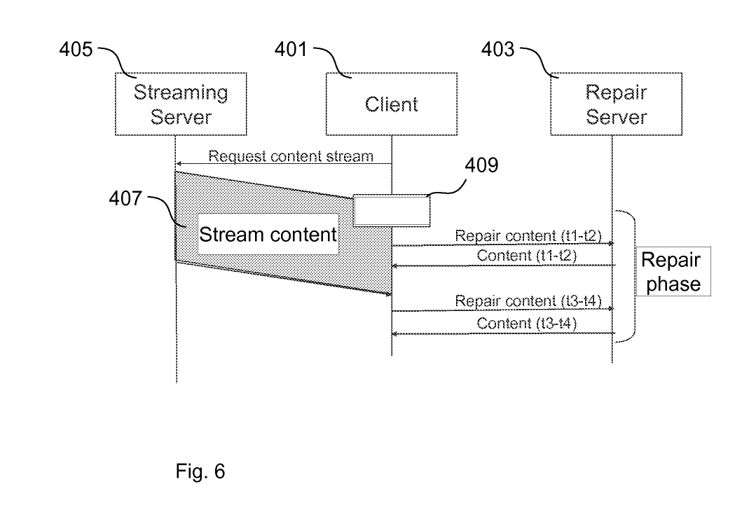

FIG. 6 shows a block diagram of a communication system comprising the client entity 401, the data replacement entity 403 forming e.g. a repair server and the network entity 405 forming e.g. a streaming server as described with reference to FIG. 4.

As depicted in FIG. 6, the client entity 401 may transmit a request content stream to the network entity 405 over a communication network. Upon receiving the request content stream, the network entity 405 may transmit a stream content 407 to the client entity 401. Upon receiving the stream content 407, the client entity 401 may start recording and logging the same using e.g. a recording and logging entity 409. If a quality of the stream content, e.g. if a quality of scheduled data comprised by the stream content, does not comply with a quality requirement then the client entity 401 may transmit a data replacement signal to the data replacement entity 403 in order to obtain replacement data with respect to e.g. a time interval t1-t2 in order to repair the received content. In response thereto, the data replacement entity may transmit the requested content within the time interval t1-t2 to the client entity 401. Correspondingly, the client entity 401 may further request another replacement data to replace scheduled data within a time interval t3-t4. Correspondingly, the data replacement entity 403 may transmit the further replacement data representing the requested content, wherein the client entity 401 may replace the scheduled data by the further received scheduled data in order to repair the streamed content.

With reference to streaming applications, the scheduled data, e.g. video data, may adaptively be streamed via RTP to the client entity 401, wherein the recording and logging entity 409 may store information indicating the quality of the received video data. In addition, the client entity 401 may also store the streamed data. The client entity 401 may exploit the quality logs in order to repair the scheduled data in case the quality of the stored data does not meet certain, e.g. minimum, quality requirement. It may download all those parts of the video from an HTTP server where the quality of the recorded video was to low. By merging the recorded “good” parts of the video and the downloaded repair segments, the client creates a video file with good quality.

With reference to the data replacement phase, the client entity 401 may record the scheduled data into a file and determine which sections of the recorded file need to be repaired using the information provided e.g. by the logging entity 409. These may be sections for which the quality was below some certain user or pre-defined threshold. By inspecting the recorded information, the client entity 401 may determine at which time the quality was too low, i.e., for which time intervals the video should be repaired, i.e. replaced. For these intervals, the client entity 401 may request a higher quality version of the media data from a data replacement entity 405 e.g. via HTTP. In these requests, the client entity 401 may either ask for time intervals or for sections of a file, e.g. byte-ranges. The received high quality versions may then be merged with the already stored data to create a local copy with the desired quality.

Instead of using a threshold, the client entity 401 may also submit a data replacement request for missing of the “worst” portion of the stream. After it has received it, it requests the next “worst” portion etc, until it receives an error message from the server, indicating that no better quality is available anymore. This strategy would also remove the requirement to have knowledge about the available quality at the client.

When requesting specific sections of a file stored at the data replacement entity 401, a HTTP byte-range requests, may be transmitted. The client entity 401 may map respective time intervals of the sections which shall be replaced (and thus repaired) to the section of the file at the data replacement entity 403. One way to achieve this is that the client entity 401 downloads, e.g. via the HTTP byte range requests, the header of the media file from the data replacement entity 403. The header of a MPEG4 file [MP4FF] contains a time-to-sample table.

From the time-to-sample table and from the recorded time intervals, the client entity 401 may determine the portions of the file stored at the data replacement entity 403 which are necessary in order to replace recorded sections of lower quality. Next, the client entity 401 may request these portions via HTTP byte range requests and replace the corresponding low quality sections in the recorded file. Thus, a standard HTTP server without any modifications may be used for transmitting the above mentioned requests.

Furthermore, a server-side time-to-byte mapping may be performed. By way of example, the client entity 401 may request the missing parts directly from the data replacement entity 403 supplying the time intervals in one or multiple HTTP requests, which may be performed upon the basis of a HTTP extension or may be time embedded into a URL. The HTTP header is extendable, e.g. upon the basis of the known “Pragma” directive. Generally, an additional header field may be defined in order to convey the time information.

According to some implementations, the requested time range may be embedded into the URL as follows: “resource_type://domain:port/filepathname?query_string#anchor”. Particularly the “query_string or the filepathname” may be used to indicate the time interval(s).

According to some implementations, the data replacement entity 403 may extract the information on the time interval(s) from the request and use, e.g., information from the requested high quality video file or time-to-sample table or from an external index file providing such a mapping to map the requested time interval to byte ranges in a file. The requested portion of the file, as indicated through the byte range, may then be sent back to the client entity 401.

With reference to FIG. 6, the above described phases of recording and streaming may be performed in parallel to the streaming phase, after the streaming phase or at both points in time. An exact timing of the repair phase may be determined by the client entity 401 and may be influenced by the actual network connection condition that the client entity 401, which may be a mobile client, experiences. Thus, upon bad connection conditions, the client entity 401 may decide to wait until the streaming phase is over to avoid even worse conditions for the streaming. In contrary when the access condition of the client entity 401 improves during the streaming phase then the client entity 401 may decide to request repair parts immediately.

According to some implementations, the client entity 401 may decide not to repair, e.g. short sections of video with too low quality. In addition, the client entity 401 may also decide to download sections, e.g. scheduled data, when the high quality version is already available, e.g. when any signaling is reduced as two long sections of low quality surround a short section of high quality.

According to some implementations, the HTTP based repair principle may also be used in case the client entity 401 does not receive any video content for some periods of time. In this case, the missing interval can be derived from the time stamps surrounding the missing period and the same method as described above can be used. Alternatively, a server based logging may be performed.

According to some implementations, the quality of the received data, e.g. video data, may be signaled together with the video and logged at the client entity 401. Alternatively, it may be assumed that the logging process may be performed at the network entity 405, e.g. e streaming server, and is conveyed from here e.g. via the client entity 401 to the data replacement entity 405 where it may used to select the section of the movie that needs to be repaired.

According to some embodiments, the load in the network may be reduced as the client entity 401 may download only those parts of the video where the quality of the recorded stream was too low.

1.-18. (canceled)

19. A client entity capable of communicating over a communication network, the client entity comprising:
a receiver to receive scheduled data and to receive a quality indicator indicating a quality of the scheduled data, wherein the data is scheduled adaptively by selecting different qualities in dependence on current network conditions;
a quality monitor to monitor the quality of the scheduled data upon the basis of the quality indicator;
a processor to provide a data replacement request if the quality of the scheduled data fails to meet a quality requirement; and
a transmitter to transmit the data replacement request towards the communication network to request replacement data representing another version of the scheduled data.

20. The client entity according to claim 19, wherein the quality of the scheduled data fails to meet the quality requirement when one of the quality indicators fails to comply with a quality measure, and the quality of the scheduled data is lesser than a quality of a received further scheduled data.

21. The client entity according to claim 19, wherein the client entity is configured to replace the scheduled data with the replacement data after recording the scheduled data into a file.

22. The client entity according to claim 19, wherein the transmitter is configured to transmit the data replacement request using at least one of a Hypertext Transfer Protocol, a Uniform Resource Locator, and a Uniform Resource Identifier.

23. The client entity according to claim 19, wherein the client entity comprises one of the following:
the scheduled data is arranged at a certain position in a data stream, and wherein the data replacement request comprises information indicating the certain position, and
the replacement data is arranged at a certain position in a replacement data array, and wherein the data replacement request indicates the certain position of the replacement data in the replacement data array.

24. A replacement data entity capable of communicating over a communication network, the replacement data entity comprising:
a receiver to receive a data replacement request over the communication network, the data replacement request indicating a replacement data;
a data provider to provide the replacement data in response to the data replacement request, wherein the replacement data is scheduled with different qualities having a quality which is higher than a quality of data to be replaced and wherein upon receiving a replacement request a higher quality version of the replacement data is provided; and
a transmitter to transmit the replacement data towards the communication network.

25. The replacement data entity according to claim 24, wherein the data replacement request indicates a certain position of scheduled data within a data stream, wherein the replacement data is arranged in a replacement data array, and wherein the data provider is configured to determine a position of the replacement data in the replacement data array upon the basis of the certain position of the scheduled data in the data stream.

26. The replacement data entity according to claim 24, wherein the replacement data is arranged in a replacement data array, wherein the data replacement request indicates a certain position of the replacement data in the replacement data array, and wherein the data provider is configured to access the replacement data upon the basis of the certain position of the replacement data in the replacement data array.

27. The replacement data entity according to 24, wherein the transmitter is configured to transmit the replacement data towards the communication network upon the basis of a Hypertext Transfer Protocol.

28. A network entity for communicating over a communication network, the network entity comprising:
a scheduler to schedule data to obtain scheduled data for transmission wherein the data is scheduled adaptively by selecting different qualities in dependence on current network conditions;
a qualifier to provide a quality indicator indicating a quality of the scheduled data; and
a transmitter to transmit the scheduled data and the quality indicator over the communication network.

29. The network entity according to claim 28, further comprising a composer to compose a transmission frame upon the basis of the scheduled data and the quality indicator.

30. The network entity according to claim 28, wherein the transmitter is configured to transmit information allowing a proper interpretation of the quality indicator.

31. The network entity according to claim 28, wherein the quality indicator indicates at least one of:
a data rate such as an audio data rate and a video data rate,
a compression rate such as an audio compression rate and a video compression rate,
a resolution at which the scheduled data represents certain information or content, such as an audio resolution and a video resolution, and
a compression error.

32. A communication system, comprising:
a client entity comprising:
a receiver to receive scheduled data and to receive a quality indicator indicating a quality of the scheduled data, wherein the data is scheduled adaptively by selecting different qualities in dependence on current network conditions;
a quality monitor to monitor the quality of the scheduled data upon the basis of the quality indicator;
a processor to provide a data replacement request if the quality of the scheduled data fails to meet a quality requirement; and
a transmitter to transmit the data replacement request towards the communication network to request replacement data representing another version of the scheduled data;
a replacement data entity comprising:
a receiver to receive a data replacement request over the communication network, the data replacement request indicating a replacement data;
a data provider to provide the replacement data in response to the data replacement request, wherein the replacement data is scheduled with different qualities having a quality which is higher than a quality of data to be replaced and wherein upon receiving a replacement request a higher quality version of the replacement data is provided; and
a transmitter to transmit the replacement data towards the communication network; and
a network entity comprising:
a scheduler to schedule data to obtain scheduled data for transmission wherein the data is scheduled adaptively by selecting different qualities in dependence on current network conditions;
a qualifier to provide a quality indicator indicating a quality of the scheduled data; and
a transmitter to transmit the scheduled data and the quality indicator over the communication network.

33. A method for managing data being receivable over a communication network, the method comprising:
receiving scheduled data, wherein the data is scheduled adaptively by selecting different qualities in dependence on current network conditions;
receiving a quality indicator indicating a quality of the scheduled data;
monitoring the quality of the scheduled data upon the basis of the quality indicator;
providing a data replacement request if the quality of the scheduled data fails to meet a quality requirement; and
transmitting the data replacement request towards the communication network to request replacement data representing another version of the scheduled data.

34. A method for providing replacement data over a communication network, the method comprising:
receiving a data replacement request over the communication network, the data replacement request indicating the replacement data;
providing the replacement data in response to the data replacement request, wherein the replacement data is scheduled with different qualities having a quality which is higher than a quality of data to be replaced and wherein upon receiving a replacement request a higher quality version of the replacement data is provided; and
transmitting the replacement data towards the communication network.

35. A method for communicating data over a communication network, the method comprising:
scheduling data to obtain scheduled data for transmission, wherein the data is scheduled adaptively by selecting different qualities in dependence on current network conditions;
providing a quality indicator indicating a quality of the scheduled data; and
transmitting the scheduled data and the quality indicator over the communication network.

36. A method for communicating, the method comprising:
managing data being receivable over a communication network comprising:
receiving scheduled data, wherein the data is scheduled adaptively by selecting different qualities in dependence on current network conditions;
receiving a quality indicator indicating a quality of the scheduled data;
monitoring the quality of the scheduled data upon the basis of the quality indicator;
providing a data replacement request if the quality of the scheduled data fails to meet a quality requirement; and
transmitting the data replacement request towards the communication network to request replacement data representing another version of the scheduled data;
providing replacement data over the communication network comprising:
receiving a data replacement request over the communication network, the data replacement request indicating the replacement data;
providing the replacement data in response to the data replacement request, wherein the replacement data is scheduled with different qualities having a quality which is higher than a quality of data to be replaced and wherein upon receiving a replacement request a higher quality version of the replacement data is provided; and
transmitting the replacement data towards the communication network; and
communicating data over the communication network comprising:
scheduling data to obtain scheduled data for transmission, wherein the data is scheduled adaptively by selecting different qualities in dependence on current network conditions;
providing a quality indicator indicating a quality of the scheduled data; and
transmitting the scheduled data and the quality indicator over the communication network.
